(19) United States
(12) Patent Application Publication
(10) Pub. No.: US 2026/0305600 A1
(43) Pub. Date: Oct. 8, 2026

(54) SYSTEMS AND METHODS FOR ANIMAL DETERRENCE USING MULTI-MODAL SENSING AND REINFORCEMENT-LEARNING-BASED ACOUSTIC ACTUATION

(71) Applicant: UNIVERSITY OF MARYLAND, BALTIMORE COUNTY, Baltimore, MD (US)

(72) Inventors: Bipendra BASNYAT, Baltimore, MD (US); Nirmalya ROY, Baltimore, MD (US)

(21) Appl. No.: 19/635,968

(22) Filed: Apr. 1, 2026

Related U.S. Application Data
(60) Provisional application No. 63/782,050, filed on Apr. 2, 2025.

(51) Int. Cl. A01M 29/18; A01M 29/10; G06V 40/10

(52) U.S. Cl. CPC A01M 29/18; A01M 29/10; G06V 40/10

(57) ABSTRACT

Systems and methods for animal deterrence using multi-modal sensing and reinforcement-learning-based acoustic actuation are disclosed. According to an aspect, a system includes one or more activity sensors configured to detect activity in a monitored area. The system also includes one or more imaging sensors configured to acquire image data of an animal in the monitored area in response to detection of activity by the at least one activity sensor. Further, the system includes an animal deterrence manager that determines a species of the animal based on the acquired image data. The animal deterrence manager is also configured to determine a deterrent profile based on the determined species. Further, the animal deterrence manager determines a deterrent command based on the deterrent profile. The animal deterrence manager is also configured to communicate the deterrent command to a stimulus device for implementing a deterrent action.

### CROSS-REFERENCE TO RELATED APPLICATION

This application claims priority to U.S. Provisional Patent Application No. 63/782,050, filed Apr. 2, 2025, and titled AI-POWERED INVISIBLE FENCING FOR ANIMAL DETERRENCE AND CROP PROTECTION, the content of which is incorporated herein by reference in its entirety.

### FEDERALLY SPONSORED RESEARCH AND DEVELOPMENT

This invention was made with government support under Federal Grant No. 2507344, awarded by National Science Foundation. The government has certain rights to this invention.

### BACKGROUND

Human-wildlife conflict is a persistent and growing problem in agriculture worldwide. The United States Department of Agriculture (USDA) estimates that wildlife damage to crops exceeds $4.5 billion annually in the United States alone. In specialty crop agriculture, including berries, tree fruits, vineyards, nursery stock, and organic produce—the problem is particularly acute because many conventional chemical deterrents are prohibited or restricted under organic certification standards, and physical barriers such as fencing are impractical or cost-prohibitive for large acreages.

Conventional wildlife deterrent approaches include static ultrasonic emitters, propane cannons, visual scarecrows, chemical repellents, and physical fencing. Each of these approaches suffers from well-documented limitations.

In some technologies, static ultrasonic emitters emit a fixed-frequency ultrasonic signal intended to be aversive to target animals. However, these devices operate without any detection capability and emit signals continuously or on fixed timers, leading to rapid habituation. Animals exposed to predictable, non-varying ultrasonic stimuli learn within days to weeks that the stimulus poses no genuine threat and cease to exhibit avoidance behavior. Furthermore, such devices lack species specificity—the same signal is emitted regardless of whether the intruding animal is a deer, rabbit, squirrel, or bird, despite the fact that these species have markedly different audiograms and aversive frequency ranges.

In other technologies, propane cannons and pyrotechnic deterrents produce loud audible blasts at random or timed intervals. While initially effective, these devices also suffer from habituation, and their use has been increasingly restricted or banned due to noise complaints from neighboring properties. They offer no species discrimination and cannot modulate their output in response to animal behavior.

More advanced systems have integrated computer vision with deterrent actuation. In one technology, a bird deterrence system uses convolutional neural networks (CNNs) for background subtraction and bird detection, coupled with laser or audio deterrent devices. However, this system is limited to birds, relies on background-subtraction methods rather than direct species classification, and does not employ adaptive learning to modify its deterrent strategy based on observed animal responses over time. The system lacks any mechanism for detecting or quantifying habituation.

Another technology utilizes a radar-based bird deterrent system that measures bird trajectories and includes an expert system to alter deterrent configuration in response to measured reductions in performance from habituation. While this system addresses habituation measurement, it operates using radar rather than computer vision, is designed for large-scale installations (airports, tailings ponds), and does not implement autonomous strategy adaptation.

Some works disclose an Anti-adaptive Harmful Birds Repelling (AHBR) method that uses model-free reinforcement learning to vary acoustic deterrent patterns and prevent bird adaptation in orchards. While these works demonstrate the utility of RL for anti-habituation acoustic deterrence, it is limited to birds, does not provide for species detection, and does not address the multi-species agricultural context where different animal species require fundamentally different deterrent parameters.

Other technologies utilize species-specific acoustic deterrence for marine mammals that exploits the acoustic startle response reflex. While these technologies address species specificity and habituation resistance through startle-response exploitation, it is specific to marine environments and does not integrate visual detection, edge computing, or machine learning.

Some works describe an animal repellent system with a controller that varies ultrasonic and sonic signals according to non-periodic time and frequency patterns. This system uses PIR motion detection as its sole sensing modality and has no capability to identify the species of the detected animal, precluding species-specific deterrent optimization.

Some systems that utilize acoustic bird repellents in orchards has integrated YOLO-based bird detection with ultrasonic repellent actuation. However, these systems employ a binary detect-and-blast approach, and their deterrent modulation is limited to fixed frequency patterns.

In view of the foregoing, there exists a need for improved non-lethal wildlife deterrence systems and techniques that maintain long-term deterrence efficacy in various environments, such as agricultural settings.

### SUMMARY OF THE DISCLOSURE

The presently disclosed subject matter relates to systems and methods for animal deterrence using multi-modal sensing and reinforcement-learning-based acoustic actuation. In aspects, disclosed herein are intelligent, adaptive, non-lethal wildlife deterrence systems that can detect and classify multiple wildlife species in real time, deploy species-specific acoustic deterrents that are continuously optimized through reinforcement learning, and quantitatively monitor and mitigate habituation to maintain long-term deterrence efficacy in agricultural settings.

According to an aspect, a system includes one or more activity sensors configured to detect activity in a monitored area. The system also includes one or more imaging sensors configured to acquire image data of an animal in the monitored area in response to detection of activity by the at least one activity sensor. Further, the system includes an animal deterrence manager configured to determine a species of the animal based on the acquired image data. The animal deterrence manager is also configured to determine a deterrent profile based on the determined species. Further, the animal deterrence manager is configured to determine a deterrent command based on the deterrent profile. The animal deterrence manager is also configured to communicate the deterrent command to a stimulus device for implementing a deterrent action. Further, the animal deterrence manager is configured to observe a behavioral response of the animal to the deterrent action using the at least one imaging sensor. The animal deterrence manager is also configured to update a learned policy based on the observed behavioral response of the animal.

According to another aspect, a system includes one or more activity sensors configured to detect activity in a monitored area. The system also includes one or more imaging sensors configured to acquire image data of an animal in the monitored area in response to detection of activity by the at least one activity sensor. Further, the system includes an animal deterrence manager configured to classify a detected animal by species by use of a machine-learned model based on the image data. Further, the animal deterrence manager is configured to determine a system state based on the classified species, a time-of-day indicator, an environmental condition indicator, and/or a habituation metric associated with the classified species. The animal deterrence manager is configured to determine deterrent control data based at least on the system state. Further, the animal deterrence manager is configured to cause at least one stimulus device to implement a deterrent action according to the deterrent control data. The animal deterrence manager is configured to analyze subsequent sensor data to determine a behavioral response of the animal to the deterrent action. Further, the animal deterrence manager is configured to update a learned policy that governs selection of deterrent actions and the habituation metric based at least on the determined behavioral response.

According to another aspect, a system includes an animal deterrence manager configured to maintain, for each of a plurality of wildlife species, a habituation score quantifying a temporal trend in behavioral responsiveness of the respective species to deterrent stimuli implemented by the system. Further, the animal deterrence manager is configured to, for each deterrent encounter with an animal of a given species, compute a response quality metric from sensor data indicative of a behavioral response of the animal to a deterrent action. The animal deterrence manager is configured to update the habituation score for the given species based on the computed response quality metric. Further, the animal deterrence manager is configured to modify one or more control parameters governing selection of deterrent actions so as to adjust at least one of a diversity, intensity, or timing of deterrent stimuli applied to the given species in response to the habituation score meeting at least one escalation condition. The animal deterrence manager is configured to transmit an alert to an operator via a remote management interface in response to the habituation score meeting an alert condition.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of a system for animal deterrence in accordance with embodiments of the present disclosure;

FIG. 2 is a flow diagram of a method for adaptive animal deterrence in accordance with embodiments of the present disclosure;

FIG. 3 is a high-level system architecture diagram of the adaptive wildlife deterrence system showing the vision pod, sound pod, wireless communication link, and remote management interface;

FIG. 4 is a detailed block diagram of the vision pod showing the imaging sensor, PIR sensor, inference pod, wireless transceiver, and power management subsystem;

FIG. 5 is a detailed block diagram of the sound pod showing the microcontroller, speaker array, wireless transceiver, and power subsystem;

FIG. 6 is a flow diagram of the detection and classification pipeline executing on the inference pod;

FIG. 7 is a state diagram of the reinforcement learning controller showing the state space, action space, and reward computation;

FIG. 8 is a flow diagram of a habituation scoring engine showing the computation of per-species habituation scores and escalation trigger logic;

FIG. 9 is a schematic of the closed-loop feedback architecture showing continuous visual observation of animal behavioral response during active deterrence;

FIG. 10 is a diagram of exemplary species-specific deterrent profiles showing frequency ranges, modulation patterns, and escalation sequences for deer (Odocoileus virginianus), eastern cottontail rabbit (Sylvilagus floridanus), eastern gray squirrel (Sciurus carolinensis), and common starling (Sturnus vulgaris);

FIG. 11 is a deployment topology diagram showing multiple vision pods and sound pods distributed across an agricultural field with overlapping coverage zones;

FIG. 12 is a timing diagram showing a representative deterrent escalation sequence triggered by habituation detection for a single deer encounter;

FIG. 13 is a block diagram of the data logging and analytics subsystem including the remote management interface;

FIG. 14 illustrates a schematic of the dual-spectral imaging configuration showing combined RGB and infrared sensor operation for nocturnal detection;

FIGS. 15, 16, and 17 are images of a vision pod, an inference pod, and a sound pod, respectively, in accordance with embodiments of the present disclosure;

FIG. 18 illustrates a sound pod printed circuit board (PCB) including an ESP32 microcontroller, a PCM5102 DAC, a PAM8610 amplifier, a PIR motion sensor, an SD card module, and a current sensor;

FIG. 19 is an image showing an integrated AI system in accordance with embodiments of the present disclosure as deployed on an active specialty crop farm; and

FIG. 20 shows an example screenshot of a cloud-based remote management interface showing real-time detection events, habituation score dashboards, deterrent activation logs, and system health monitoring.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

In embodiments, systems disclosed herein can provide adaptive animal deterrence. In an example, a system can detect motion in a monitored agricultural area using a passive infrared (PIR) sensor to trigger activation of a vision pipeline. Further, the system can acquire image data of the detected motion event using an imaging sensor. The system can classify the detected animal by species using an edge-deployed deep learning model. Further, the system can retrieve a species-specific deterrent profile from a deterrent profile database, the deterrent profile specifying at least a frequency range, amplitude envelope, modulation pattern, and temporal duration derived from the audiogram of the classified species. The system can also select an acoustic deterrent action from the deterrent profile using a reinforcement learning controller, the controller maintaining a policy that maps system states to deterrent actions. Further, the system can transmit a deterrent command to one or more sound pods via a wireless communication interface. The system can emit the selected acoustic deterrent signal through the one or more sound pods; continuously observing the animal's behavioral response to the emitted deterrent signal using the imaging sensor. Further, the system can compute a reward signal for the reinforcement learning controller based on the observed behavioral response. The system can also update the reinforcement learning policy based on the computed reward. Further, the system can update a habituation score for the classified species based on the magnitude and latency of the observed behavioral response relative to historical baselines.

In embodiments, systems disclosed herein can provide for distributed animal deterrence. In an example, a system includes one or more vision pods comprising an imaging sensor, a passive infrared motion sensor, an inference pod, and a wireless transceiver. The system can also include one or more sound pods comprising a programmable microcontroller, a speaker array capable of emitting signals across ultrasonic and audible frequency ranges, and a wireless transceiver. Further, the system can include a species classification module executing on the inference pod, the module comprising a lightweight convolutional neural network trained for multi-species wildlife detection and classification. The system can also include a reinforcement learning controller executing on the inference pod, the controller maintaining a learned policy mapping system states to deterrent actions. The system state can include at least the classified species, time of day, ambient environmental conditions, and a habituation score for the classified species. A deterrent profile database can store species-specific acoustic deterrent parameters. A habituation scoring engine can compute and maintain a per-species habituation score based on temporal trends in animal behavioral responses to deterrent stimuli. A feedback loop can implement behavioral response observations from the imaging sensor that are used to compute reward signals that update the reinforcement learning policy.

In embodiments, a non-transitory computer-readable medium is provided that stores instructions that, when executed by an inference pod in an animal deterrence system, cause the processor to perform the methods and processes described herein.

Systems disclosed herein can address habituation problems through a three-layer approach: (1) reinforcement learning continuously varies the deterrent strategy so that the animal's experience is non-stationary, preventing associative learning that the stimulus is harmless; (2) species-specific deterrent profiles ensure that acoustic parameters target the maximum sensitivity ranges of each species' auditory system; and (3) a quantitative habituation scoring engine detects declining responsiveness and triggers escalation protocols before deterrence failure occurs.

As referred to herein, an “activity sensor” to any sensor or combination of sensors configured to detect activity within a monitored area, such as motion or presence of an object or animal, and to generate a corresponding detection or trigger signal. The activity sensor can include, without limitation, a passive infrared (PIR) motion sensor, radar sensor, ultrasonic rangefinder, microwave motion detector, image-based motion detector, or other sensor technology suitable for detecting activity in the monitored area.

As used herein, an “imaging sensor” refers to any sensor or sensor assembly configured to acquire image data representing at least a portion of a monitored area, including still images or video frames. The imaging sensor can include, without limitation, a digital camera module, a dual-spectral imaging system having one or more RGB and/or infrared image sensors, a thermal imaging sensor, or any other device capable of producing image data suitable for detection and classification of animals or their behavior.

As used herein, a “stimulus device” refers to any device or assembly of one or more actuators configured to implement a deterrent action in response to a control or deterrent command, by outputting one or more deterrent stimuli intended to influence animal behavior. The stimulus device can include, without limitation, one or more acoustic emitters (for example, speakers or ultrasonic transducers), light emitters, mechanical actuators, or combined audio-visual devices, and may be configured to emit deterrent stimuli in one or more modalities such as acoustic, visual, or mechanical stimuli.

As used herein, an “animal deterrence manager” refers to processing circuitry, logic, and associated components configured to implement decision-making and control operations of an animal deterrence system, including but not limited to animal classification, state determination, deterrent profile selection, deterrent command generation, behavioral response analysis, and updating of learned policies or habituation metrics.

As used herein, a “deterrent profile” refers to data defining one or more parameters of a deterrent stimulus or deterrent action, such as frequency range, amplitude, modulation pattern, duration, intensity level, modality, actuator selection, timing, or combinations thereof, for use in configuring a stimulus device.

As used herein, “deterrent control data” refers to information derived from a deterrent profile or system state that is used to specify or parameterize a deterrent action. A “deterrent command” refers to a control message or signal that encodes deterrent control data and is transmitted to a stimulus device to cause implementation of a corresponding deterrent action.

As used herein, a “learned policy” refers to data and/or model parameters representing a mapping from one or more system states to one or more deterrent actions, the mapping being created or updated at least in part through a learning process, which can include but is not limited to reinforcement learning, supervised learning, or other machine-learning-based adaptation.

As used herein, a “habituation score” or “habituation metric” refers to a value or set of values indicative of a temporal trend in responsiveness of an individual animal or species to one or more deterrent actions, for example reflecting increasing or decreasing sensitivity to deterrent stimuli over multiple encounters.

As used herein, an “exploration parameters” refers to one or more configurable values used by a learned policy or control algorithm to influence a balance between selection of previously effective deterrent actions and selection of alternative or novel deterrent actions, including, without limitation, a randomization factor, temperature parameter, or probability threshold used in action selection.

As used herein, “behavioral response” refers to observable behavior of an animal following a deterrent action, as inferred from sensor data, and may include changes in position, trajectory, speed, orientation, posture, or combinations thereof. A “behavioral state” refers to a classification of behavioral response into one of a set of discrete categories, such as approaching, stationary, alert, retreating, or similar descriptors.

As used herein, a “deterrent action” refers to an operation commanded by the animal deterrence manager that causes at least one stimulus device to output one or more deterrent stimuli. A “deterrent stimulus” refers to any output generated by a stimulus device and intended to influence animal behavior, including but not limited to acoustic signals, light emissions, mechanical movements, or combinations thereof.

As used herein, “species-specific” with respect to a deterrent profile indicates that at least one parameter of the profile is selected, tuned, or derived based on characteristics of a particular animal species (for example, an audiogram or documented behavioral sensitivity) such that the profile is tailored for that species, while still optionally being usable for other species.

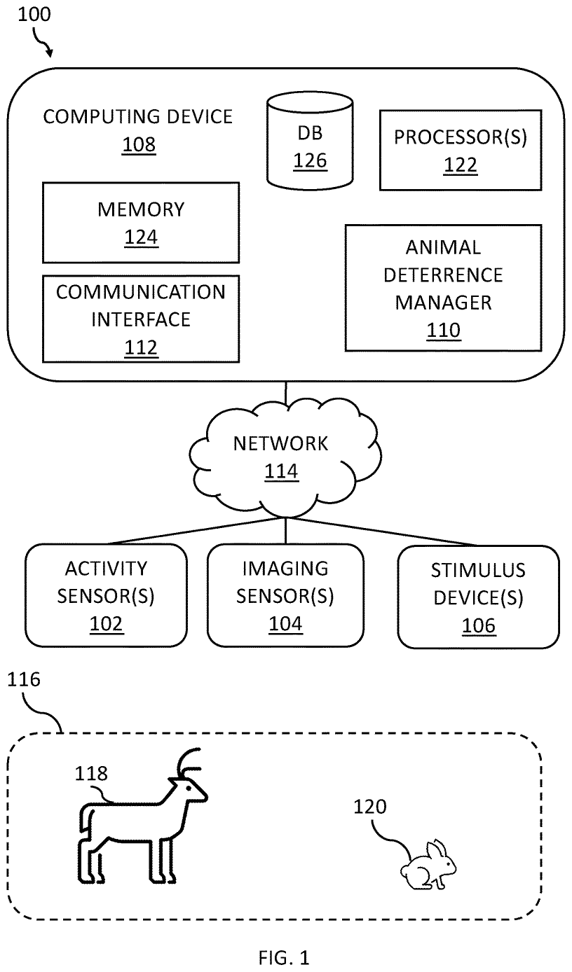

FIG. 1 illustrates a block diagram of a system 100 for animal deterrence in accordance with embodiments of the present disclosure. Referring to FIG. 1, the system 100 includes one or more activity sensors 102, one or more imaging sensors 104, and one or more stimulus devices 106. The system 100 also includes a computing device 108 having an animal deterrence manager 110 residing therein for managing operations of the activity sensor(s) 102, the imaging sensor(s) 104, and the stimulus device(s) 106. It is noted that in this example the functionalities described for the animal deterrence manager 110 are implemented within the computing device 108. However, it should be understood that in some implementations some functionalities of the animal deterrence manager 110 may be implemented by the computing device 108, and other functionalities of the animal deterrence manager 110 may be implemented by one or more other computing devices and/or one or more of the sensors 102, 104, and 106.

The computing device 108 may include a communication interface 112 configured to communicate with sensors 102, 104, and 106 and other computing devices. For example, the animal deterrence manager 110 may be configured to control the communication interface 112 to exchange commands and status information with sensors 102, 104, and 106. In examples, the communication may be conducted over a suitable wireless communication link. In the example of FIG. 1, the communication interface 112 of the computing device 108 may communicate with sensors 102, 104, and 106 via a wireless communication network 114.

Sensors 102, 104, and 106 can be suitably deployed and distributed to monitor a protected area such as an agricultural field, orchard, or similar outdoor environment. In this example, the monitored area 116 indicated by the rectangular area defined by broken lines.

Activity sensor(s) 102 are configured to detect activity within the monitored area 116 and generate a trigger signal when such activity is detected. In some implementations, the activity sensor(s) 102 can include a passive infrared (PIR) motion sensor that detects thermal motion signatures indicative of an animal entering the monitored area and outputs a corresponding trigger signal. The trigger signal can provided to the imaging sensor(s) 104 and the animal deterrence manager 110 to initiate an image acquisition and classification sequence.

The imaging sensor(s) 104 are configured to acquire image data of the monitored area 116 and objects (e.g., animals such a deer 118 or a rabbit 120) in response to detection of activity (e.g., movement of animals such as the deer 118 or the rabbit 120) by the activity sensor 20. In embodiments, the imaging sensor(s) 104 include a camera that captures still images or video frames of the monitored area 116 following receipt of the trigger signal. In embodiments, the camera can employ a dual-spectral imaging configuration including both an RGB image sensor and a near-infrared (NIR) image sensor so that image data can be captured under varying lighting conditions, including daytime and low-light or nocturnal conditions. The imaging sensor(s) 104 can supply image data of any detected animal to the animal deterrence manager 110 for further processing.

Functionalities of the animal deterrence manager 110 can be implemented by suitable hardware, software, and/or firmware. For example, the computing device 108 includes one or more processors 122, memory 124, and associated circuitry (not shown for simplicity of illustration) configured to implement functionalities of the animal deterrence manager 110 described herein. Using the image data acquired by the imaging sensor(s) 104, the animal deterrence manager 110 can determine a species of a detected animal by executing a machine-learned classification model. In embodiments, the machine-learned classification model includes an object detection model that can process the image data to output a bounding box corresponding to the detected animal within a field of view of the imaging sensor(s) 104 and a species label associated with the detected animal. The object detection model may be based on a You Only Look Once (YOLO) architecture or a MobileNet-SSD architecture that is optimized for edge deployment with reduced latency and power consumption.

Based on the determined species, the animal deterrence manager 110 can determine a deterrent profile specifying how the system 100 responds to the detected animal. In embodiments, the animal deterrence manager 110 can retrieve deterrent parameters associated with the determined species from a deterrent profile database 126. Each deterrent profile may specify one or more parameters including, for example, a frequency range, an amplitude envelope, a modulation pattern, a temporal duration, and an intensity level for a deterrent stimulus. In embodiments, the deterrent profile can be selected from among species-specific deterrent profiles stored in the deterrent profile database 126, where each species-specific profile is derived from or informed by an audiogram or other sensory data corresponding to a respective animal species.

Using the selected deterrent profile, the animal deterrence manager 110 can generate a deterrent command that encodes or references the appropriate deterrent control data. The deterrent command can be communicated to one or more stimulus devices 106 via the communication interface 112. In embodiments, the communication interface 112 can support wireless communication so that the animal deterrence manager 110 can control stimulus devices distributed throughout the monitored area without wired connections.

Stimulus devices 106 can implement a deterrent action in response to receipt of a deterrent command. In embodiments, stimulus device(s) 106 can include one or more acoustic emitters, such as an array of speakers, that can emit an acoustic deterrent signal according to the parameters specified in the deterrent profile. The acoustic emitter may be configured to emit signals in one or more predetermined ultrasonic frequency ranges and/or one or more predetermined audible frequency ranges so as to target frequency bands to which particular species are most sensitive. In embodiments, the stimulus device(s) 106 can include a speaker array having a piezoelectric ultrasonic transducer for emission of high-frequency ultrasonic signals and a dynamic cone speaker for emission of lower-frequency audible signals. In embodiments, the stimulus device(s) 106 can include other deterrent actuators such as light emitters, mechanical actuators, or combined audio-visual devices, enabling multi-modal deterrent actions that extend beyond acoustic output.

In embodiments, multiple stimulus devices 106 can be distributed across the monitored area 116 so that deterrent actions can be localized or coordinated to guide animals away from sensitive regions. The animal deterrence manager 110 can select a subset of the plurality of stimulus devices 106 to receive the deterrent command based at least on an estimated location of a detected animal within the monitored area 116, which may be inferred from the image data captured by the imaging sensor(s) 104 or other location-sensing techniques.

During and following implementation of a deterrent action, the animal deterrence manager 110 can observe a behavioral response of the animal by analyzing subsequent sensor data, which can include additional image data acquired by the imaging sensor(s) 104. In embodiments, the animal deterrence manager 110 can track one or more behavioral indicators such as a trajectory, velocity, or heading change of the animal over an observation interval following execution of the deterrent action. Based on these indicators, the animal deterrence manager 110 may classify the behavioral response into one of a plurality of behavioral states including, for example, approaching, stationary, alert, and retreating. The behavioral state and other observed characteristics can be provided as feedback to an internal control policy maintained by the animal deterrence manager 110.

The animal deterrence manager 110 can maintain a learned policy that maps system states to deterrent actions and governs subsequent selection of deterrent profiles or commands. A system state used by the learned policy may include the determined species of the animal, a time-of-day indicator, an ambient light level, and/or one or more measures of prior responsiveness of the determined species to deterrent actions. In embodiments, the learned policy is implemented and updated using a reinforcement learning algorithm. For example, the animal deterrence manager 110 can compute a reward signal indicative of the effectiveness of a particular deterrent action based on the observed behavioral response, such as whether the animal exits a protected zone within a specified observation period after execution of the deterrent action, and adjust the learned policy based on the reward signal.

In addition to updating the learned policy, the animal deterrence manager 110 can maintain, for each of a plurality of species, a habituation score that reflects a temporal trend in behavioral responsiveness of the respective species to deterrent actions administered by the system 100. The habituation score for a given species may be updated over multiple deterrent encounters and can be used to detect when animals of that species begin to exhibit reduced responsiveness to previously effective deterrent stimuli. When the habituation score for the determined species exceeds a first threshold, the animal deterrence manager 110 may increase an exploration parameter used by the learned policy so that the policy more frequently selects alternative or novel deterrent actions for that species. When the habituation score exceeds a second, higher threshold, the animal deterrence manager 110 may trigger an escalation protocol that modifies at least one deterrent parameter, for example by increasing intensity, duration, or introducing additional modalities in the deterrent profile for subsequent deterrent actions.

In embodiments, the animal deterrence manager 110 may be implemented as an edge processor located within or in close proximity to a vision node that includes an activity sensor 102 and/or an imaging sensor 104. The edge processor can perform animal species determination, deterrent profile determination, deterrent command generation, observation and classification of behavioral responses, maintenance of habituation scores, and update of the learned policy without requiring continuous connectivity to a remote server during real-time operation.

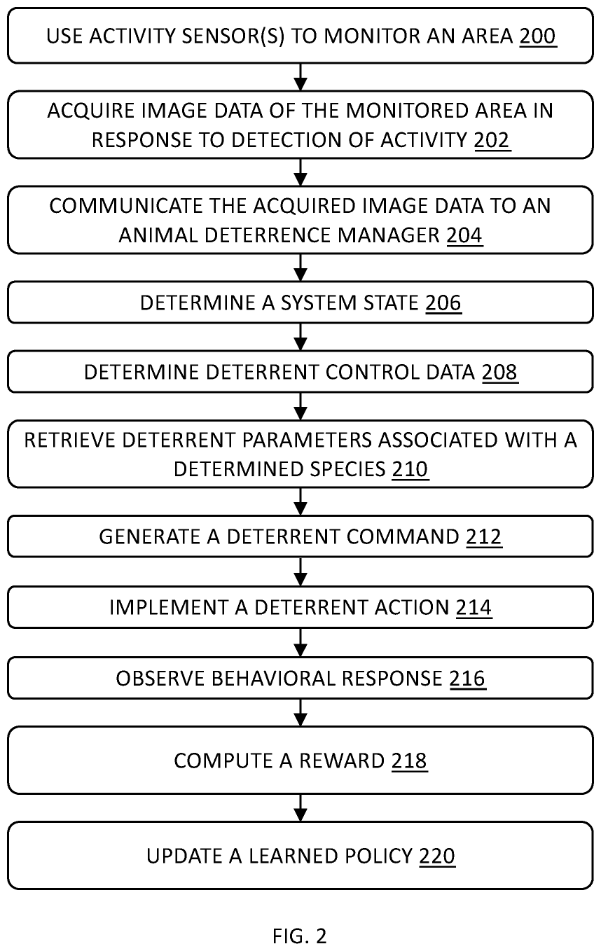

FIG. 2 illustrates a flow diagram of a method for adaptive animal deterrence in accordance with embodiments of the present disclosure. The method is described by example as being implemented by system 100 shown in FIG. 1. However, it should be understood that the method may alternatively be implemented by any other suitable system for animal deterrence.

Referring to FIG. 2, the method includes using 200 one or more activity sensors to monitor an area and detect activity within the monitored area. For example, the activity sensor(s) 102 shown in FIG. 1 can monitor a protected or monitored area 116 for activity. The activity can include movement of an animal entering the field of view. In some embodiments, detecting activity can include detecting a thermal motion signature using a passive infrared motion sensor and generating a corresponding trigger signal.

The method of FIG. 2 includes acquiring 202 image data of the monitored area in response to detection of activity. Continuing the aforementioned example, responsive to detection of activity, a trigger signal causes the imaging sensor(s) 104 to acquire image data of the monitored area 116. The acquired image data can include image data of any detected animal such as the deer 118 or rabbit 120.

The method of FIG. 2 includes communicating 204 the acquired image data to an animal deterrence manager. Continuing the aforementioned example, the imaging sensor(s) 104 can wirelessly communicate the acquired image data to the computing device 108. At the computing device 108, the animal deterrence manager 110 can executes a machine-learned classification model to analyze the image data and determine a species of the detected animal. In some examples, the animal deterrence manager 110 runs an object detection model that outputs a bounding box and a species label for the detected animal within a field of view of the imaging sensor(s) 104.

The method of FIG. 2 includes determining 206 a system state based at least on the classified species and one or more contextual indicators, such as a time-of-day indicator, an ambient light level, and a habituation or responsiveness metric associated with the classified species. Continuing the aforementioned example, the animal deterrence manager 110 can determine206 a system state based at least on the classified species and one or more contextual indicators, such as a time-of-day indicator, an ambient light level, and a habituation or responsiveness metric associated with the classified species.

The method of FIG. 2 includes determining 208 deterrent control data by selecting or constructing a deterrent profile for the detected animal. Continuing the aforementioned example, using the system state, the animal deterrence manager 110 can determine deterrent control data by selecting or constructing a deterrent profile for the detected animal.

The method of FIG. 2 includes retrieving 210 deterrent parameters associated with the determined species. Continuing the aforementioned example, the animal deterrence manager 110 can retrieve deterrent control data or parameters associated with the determined species from the deterrent profile database 126. Each deterrent profile can specify one or more parameters such as a frequency range, amplitude envelope, modulation pattern, temporal duration, and intensity level for a deterrent stimulus.

The method of FIG. 2 includes generating 212 a deterrent command based on deterrent control data, and communicating the deterrent data to one or more stimulus devices. Continuing the aforementioned example, based on the deterrent control data, the animal deterrence manager 110 can generate a deterrent command and, via the communication interface 112 and wireless communication network 114, transmits the deterrent command to one or more stimulus devices 106 deployed within or near the monitored area 116.

The method of FIG. 2 includes implementing 214 a deterrent action in response to receipt of the deterrent command. Continuing the aforementioned example, the stimulus device(s) 106 can implement a deterrent action in response to receipt of the deterrent command. For example, one or more acoustic emitters of a stimulus device 106 may emit an acoustic deterrent signal in one or more ultrasonic and/or audible frequency ranges specified by the deterrent profile. In some embodiments, additional deterrent actuators such as light emitters or mechanical actuators may be activated to provide multi-modal deterrent stimuli. In cases that multiple stimulus devices 106 are available, a subset of the stimulus devices 106 can be selected to activate based at least on an estimated location of the detected animal within the monitored area 116.

The method of FIG. 2 includes observing 216 behavioral response of the animal by analyzing subsequent sensor data. Continuing the forementioned example, ffter initiation of the deterrent action, the animal deterrence manager 110 can observe a behavioral response of the animal by analyzing subsequent sensor data, which can include additional image data acquired by the imaging sensor(s) 104 over an observation interval following execution of the deterrent action. Observing the behavioral response may include tracking one or more motion-related indicators, such as the trajectory, velocity, or heading change of the animal, and optionally classifying the behavioral response into one of several behavioral states, including approaching, stationary, alert, and retreating.

The method of FIG. 2 includes computing 218 a reward or effectiveness signal based on the observed behavioral response. Continuing the aforementioned example, the animal deterrence manager 110 can compute a reward or effectiveness signal based on the observed behavioral response. For example, the reward signal can be a function of whether the animal exits a protected zone within a specified observation period, how quickly retreat occurs, and whether the animal exhibits a desired avoidance behavior. The reward signal and other response information may also be used to update a habituation score for the corresponding species that reflects a temporal trend in responsiveness of that species to deterrent actions.

The method includes updating 220 a learned policy that maps system states to deterrent actions using the computed reward signal and any updated habituation metric. Continuing the aforementioned example, the animal deterrence manager 110 can update a learned policy that maps system states to deterrent actions using the computed reward signal and any updated habituation metric. In embodiments, updating the learned policy includes applying a reinforcement learning algorithm that adjusts policy parameters and, when habituation scores exceed one or more thresholds, modifies exploration and/or escalation parameters so that alternative, more variable, or more intense deterrent actions are more likely to be selected in future encounters. After the learned policy has been updated, monitoring of the monitored area 116 for additional activity can continue at step 200 to thereby forming a closed-loop, adaptive deterrence cycle in which detection, classification, deterrent action, behavioral observation, and policy learning are repeatedly performed during operation of the system 100.

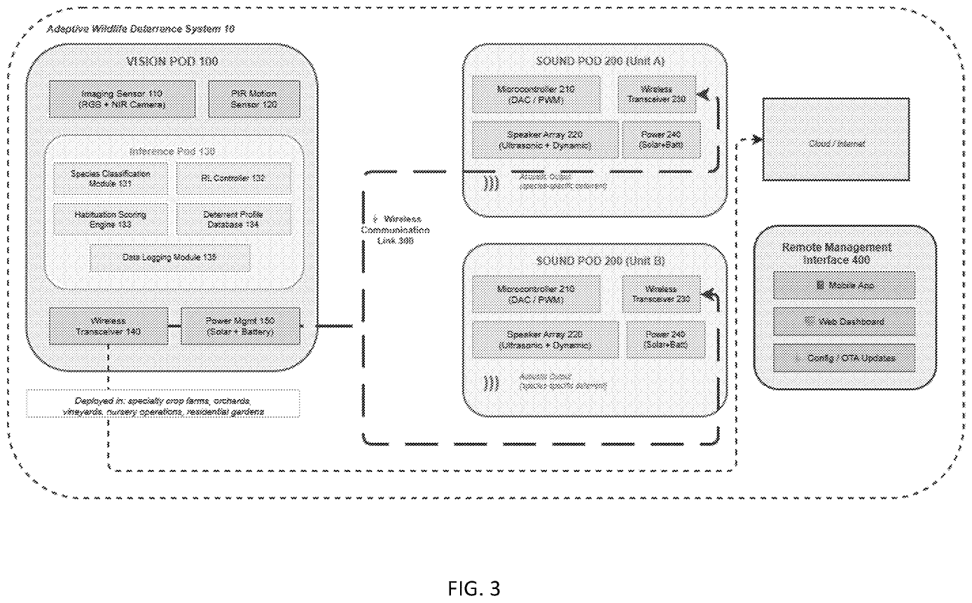

FIG. 3 illustrates a high-level system architecture diagram of the adaptive wildlife deterrence system showing the vision pod 100, sound pod 200, wireless communication link 300, and remote management interface 400. Referring now to FIG. 3, the adaptive wildlife deterrence system 10 of the present disclosure includes one or more vision pods 100, one or more sound pods 200, a wireless communication link 300 connecting the vision and sound pods, and optionally a remote management interface 400 accessible via a web or mobile application. The system 10 is designed for deployment in agricultural environments including but not limited to specialty crop farms, orchards, vineyards, nursery operations, and residential gardens.

The system 10 of FIG. 3 operates as a distributed, intelligent network in which vision pods 100 serve as perception and decision-making nodes, and sound pods 200 serve as actuation nodes. This separation of perception and actuation enables flexible deployment topologies where a single vision pod 100 may coordinate with multiple sound pods 200 to provide coverage across irregularly shaped agricultural plots, and multiple vision pods 100 may provide overlapping surveillance coverage with handoff capability.

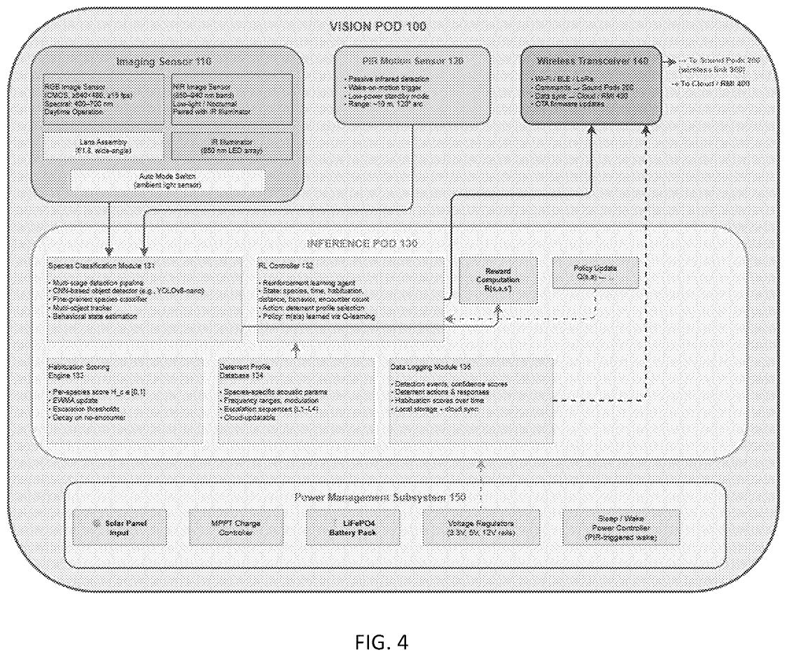

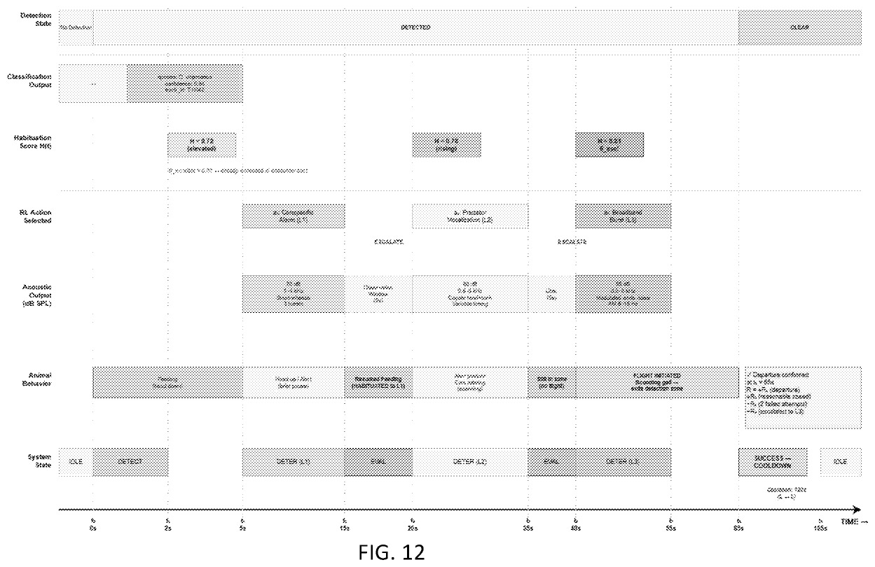

FIG. 4 illustrates a detailed block diagram of the vision pod 100 showing the imaging sensor 110, PIR sensor 120, inference pod 130, wireless transceiver 140, and power management subsystem 150. Referring to FIG. 2, the vision pod 100 includes: an imaging sensor 110, a passive infrared (PIR) motion sensor 120, an inference pod 130, a wireless transceiver 140, and a power management subsystem 150. The imaging sensor 110 comprises at minimum a camera module capable of capturing video frames at a resolution of at least 640×480 pixels and a frame rate of at least 15 frames per second. In a preferred embodiment, the imaging sensor 110 comprises a dual-spectral configuration (FIG. 12) including both an RGB image sensor and a near-infrared (NIR) image sensor, enabling detection in both daytime and low-light/nocturnal conditions. The NIR sensor operates in the 850-940 nm wavelength band and is paired with an infrared illuminator for active night-vision capability without visible light emission that might disturb the wildlife being monitored.

With continuing reference to FIG. 4, the PIR sensor 120 serves as a low-power motion trigger. In the standby state, the inference pod 130 operates in a low-power sleep mode, and the PIR sensor 120 continuously monitors for thermal motion signatures consistent with wildlife approach. Upon detecting a qualifying motion event (thermal signature above a configurable threshold at up to approximately 10-15 meters), the PIR sensor 120 generates an interrupt signal that wakes the inference pod 130 and activates the imaging sensor 110. This PIR-triggered wake architecture substantially reduces system power consumption, enabling solar-powered autonomous operation in off-grid field deployments.

The inference pod 130 can include a system-on-chip (SoC) suitable for edge AI inference, including but not limited to: Raspberry Pi Compute Module, NVIDIA Jetson Nano, Google Coral Edge TPU, or ESP32-S3 with an AI accelerator. The inference pod 130 executes: (a) the species classification module 131, (b) the reinforcement learning controller 132, (c) the habituation scoring engine 133, (d) the deterrent profile manager 134, and (e) the data logging module 135. All inference is performed on-device, requiring no cloud connectivity for real-time operation, though cloud connectivity may be used for model updates, data synchronization, and remote management.

The wireless transceiver 140 supports at least one of: Wi-Fi (802.11b/g/n), Bluetooth Low Energy (BLE), or LoRa (Long Range) wide-area network protocols. In a preferred embodiment, LoRa is used for vision-to-sound-unit communication due to its long range (up to 2+ km line-of-sight), low power consumption, and suitability for low-bandwidth command packets. Wi-Fi or BLE may be used for local configuration and data offloading.

The power management subsystem 150 comprises a rechargeable lithium-ion or lithium-iron-phosphate battery, a solar charge controller, and a solar panel input. The subsystem 150 implements dynamic power budgeting based on the current operating state (sleep, detection, active deterrence) to maintain positive energy balance under typical solar insolation conditions for the deployment latitude.

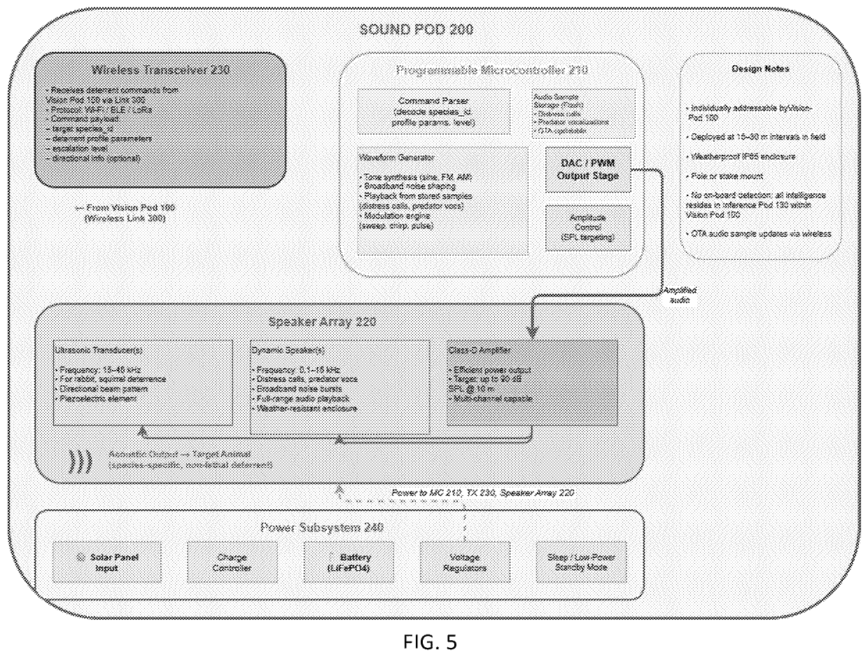

FIG. 5 illustrates a detailed block diagram of the sound pod 200 showing the microcontroller 210, speaker array 220, wireless transceiver 230, and power subsystem 240. Referring to FIG. 5, the sound pod 200 comprises: a programmable microcontroller 210, a speaker array 220, a wireless transceiver 230, and a power subsystem 240.

The microcontroller 210 comprises a low-power embedded processor (e.g., ESP32, STM32) with an integrated digital-to-analog converter (DAC) or pulse-width modulation (PWM) output and sufficient processing capability to execute real-time audio synthesis. The microcontroller 210 receives deterrent commands from the vision pod 100 via the wireless transceiver 230 and generates the corresponding acoustic waveform.

The speaker array 220 comprises at least one speaker element capable of emitting acoustic signals in the ultrasonic range (20 kHz to approximately 45 kHz) and at least one speaker element capable of emitting acoustic signals in the audible range (100 Hz to 20 kHz). In a preferred embodiment, the speaker array 220 comprises a piezoelectric ultrasonic transducer for high-frequency emission and a dynamic cone speaker for lower-frequency emission. The speaker elements may be arranged in a directional configuration to concentrate acoustic energy toward the detected animal's location.

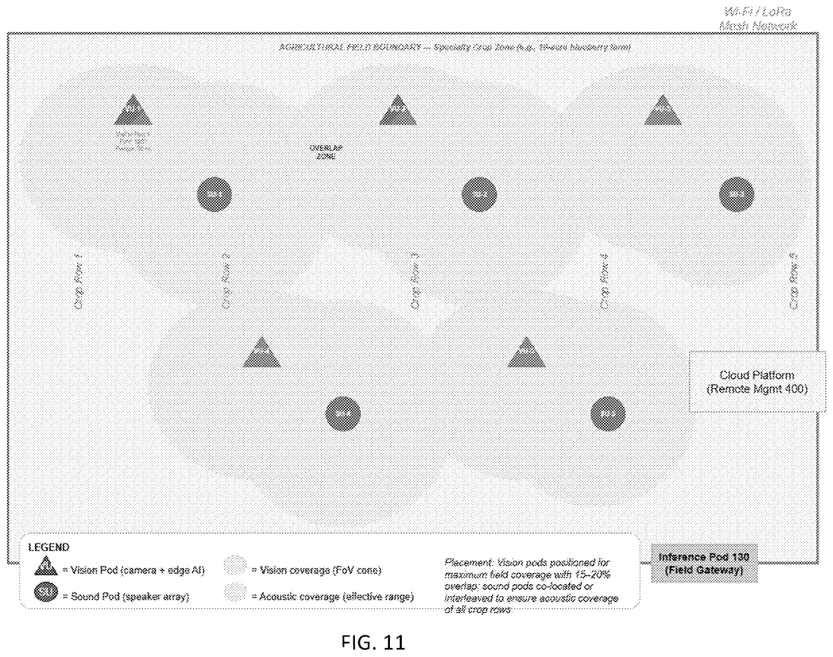

The sound pod 200 is designed for distributed field deployment. In an example deployment topology (see e.g., FIG. 11), multiple sound pods 200 are positioned throughout the protected area at intervals of approximately 15-30 meters, with each sound pod 200 addressable by the coordinating vision pod 100. Upon receiving a deterrent command specifying the target species, deterrent profile parameters, and optionally directional information, the appropriate sound pod(s) 200 activate and emit the specified acoustic signal.

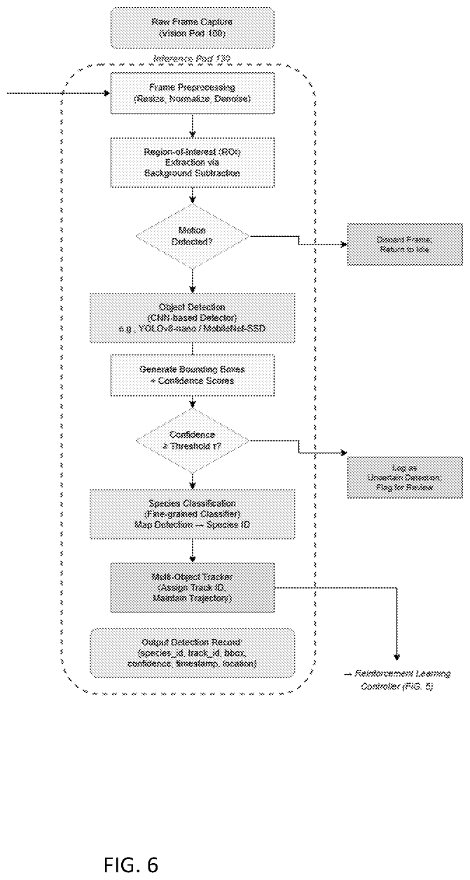

FIG. 6 illustrates a flow diagram of the detection and classification pipeline executing on the inference pod 130. Referring to FIG. 6, the species classification module 131 executes a multi-stage detection and classification pipeline on the inference pod 130.

With continuing reference to FIG. 6, at Stage 1 for Motion-Triggered Frame Acquisition: upon PIR sensor 120 triggering, the imaging sensor 110 begins capturing frames. An initial motion confirmation step using frame differencing validates that the PIR trigger corresponds to a genuine moving object rather than environmental noise (e.g., wind-blown vegetation, temperature fluctuations).

At Stage 2 for Object Detection: A lightweight object detection model detects and localizes animals within the camera's field of view. In a preferred embodiment, the detection model is based on a YOLO (You Only Look Once) architecture, specifically a version optimized for edge deployment (e.g., YOLOv5n, YOLOv8n, or a custom MobileNet-SSD variant). The model is trained on a custom dataset comprising images of target wildlife species in agricultural settings, including annotations for species class and bounding box coordinates. Quantization-aware training and knowledge distillation are applied to reduce model size and inference latency while maintaining detection accuracy above 85% mean average precision (mAP) at IoU 0.5.

At Stage 3 for Species Classification: The detected animal region is cropped and passed to a species classification head that outputs a probability distribution over known species classes. In the initial deployment, the supported species classes include but are not limited to: white-tailed deer (Odocoileus virginianus), eastern cottontail rabbit (Sylvilagus floridanus), eastern gray squirrel (Sciurus carolinensis), groundhog/woodchuck (Marmota monax), raccoon (Procyon lotor), wild turkey (Meleagris gallopavo), and common bird species (starlings, crows, blackbirds). The classification confidence threshold is configurable; detections below the threshold are handled by a default multi-species deterrent profile.

At Stage 4 for Behavioral State Estimation: For high-confidence detections, the system optionally performs a behavioral state assessment using temporal analysis of the detected animal's motion trajectory, pose, and speed. Behavioral states include: approaching, stationary/feeding, alert/startled, and retreating. This behavioral state information is used as input to the reinforcement learning controller 132 and as the basis for reward signal computation.

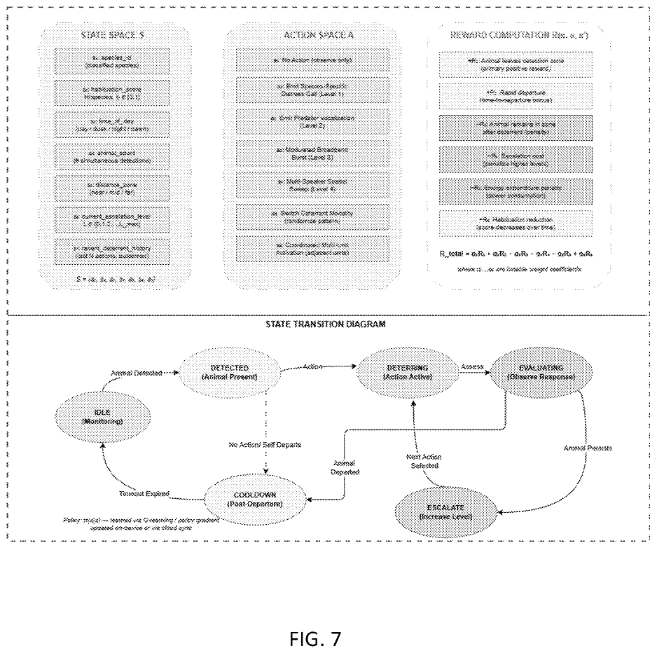

FIG. 7 illustrates a state diagram of the reinforcement learning controller showing the state space, action space, and reward computation. Referring to FIG. 7, the reinforcement learning (RL) controller 132 is the core adaptive intelligence of the system 10. The RL controller 132 learns, through trial and interaction, which deterrent actions are most effective for each species under varying conditions, and continuously updates its policy to counteract habituation.

For State Space for FIG. 7, the state vector s_t at time step t comprises:
(a) Species class c E {deer, rabbit, squirrel, groundhog, raccoon, unknown}
(b) Time of day discretized into periods: dawn, morning, midday, afternoon, dusk, night
(c) Ambient light level L categorized as: bright, overcast, twilight, dark
(d) Current habituation score H_c for species c (a continuous value between 0.0 and 1.0, described in Section 6)
(e) Number of deterrent encounters N_c for species c in the trailing 24-hour window
(f) Behavioral state of the animal: approaching, stationary, alert, retreating
(g) Distance estimate d from the detected animal to the nearest sound pod 200

The action space A comprises a set of discrete deterrent actions, each defined by a deterrent profile vector specifying:
(a) Primary frequency band (selected from the species-specific audiogram sensitivity range)
(b) Modulation type: continuous, amplitude-modulated, frequency-swept, pulsed, or burst
(c) Modulation rate and depth
(d) Signal duration (ranging from 2 seconds to 30 seconds)
(e) Intensity level (low, medium, high, escalated)
(f) Optional secondary stimulus (e.g., alternating between ultrasonic and audible ranges)

The action space is species-dependent. For each species class, a set of 8-16 candidate deterrent actions is defined in the deterrent profile database, representing variations in frequency, modulation, duration, and intensity that span the aversive range of that species' auditory system. The RL controller 132 selects among these candidate actions.

After a deterrent action a_t is executed at time t, the vision pod 100 continues to observe the animal's behavioral response through the imaging sensor 110 for an observation window of T_obs seconds (default: 30-60 seconds). The reward signal r_t is computed as:

$$r\_t = w\_ 1 \cdot R\_retreat + w\_ 2 \cdot R\_latency + w\_ 3 \cdot R\_energy - w\_ 4 \cdot R\_habituation$$

Where:
R_retreat=1.0 if the animal exits the monitored zone within T_obs; 0.5 if the animal shows alert/startled behavior but does not fully retreat; 0.0 if no behavioral change is observed; −0.5 if the animal appears to approach the sound source (indicating possible attraction or emboldened behavior).
R_latency=a decreasing function of the time elapsed between deterrent onset and the animal's first observable response (faster responses yield higher rewards).
R_energy=a penalty proportional to the energy consumed by the deterrent action, incentivizing the controller to achieve deterrence with minimal acoustic output.
R_habituation=a penalty term proportional to the current habituation score H_c, encouraging the controller to select novel or escalated actions when habituation is detected. w_1, w_2, w_3, w_4 are configurable weighting parameters.

For policy learning, the RL controller 132 maintains a Q-value table or a lightweight neural network Q-function approximator (depending on the computational capacity of the inference pod 130) mapping state-action pairs to expected cumulative rewards. In a preferred embodiment, the controller implements a Deep Q-Network (DON) variant with experience replay and epsilon-greedy exploration. The epsilon parameter decays over time but is periodically reset to a higher value (exploration boost) when the habituation scoring engine 133 detects rising habituation scores, ensuring that the controller explores novel deterrent strategies when established strategies begin to lose efficacy.

The RL policy is initialized with prior knowledge derived from published audiograms and behavioral studies for each target species, providing a warm start that avoids the need for extensive random exploration during initial deployment. Fine-tuning occurs through actual field interactions, with the policy converging toward a deployment-specific optimum that accounts for local animal populations, behaviors, and environmental conditions.

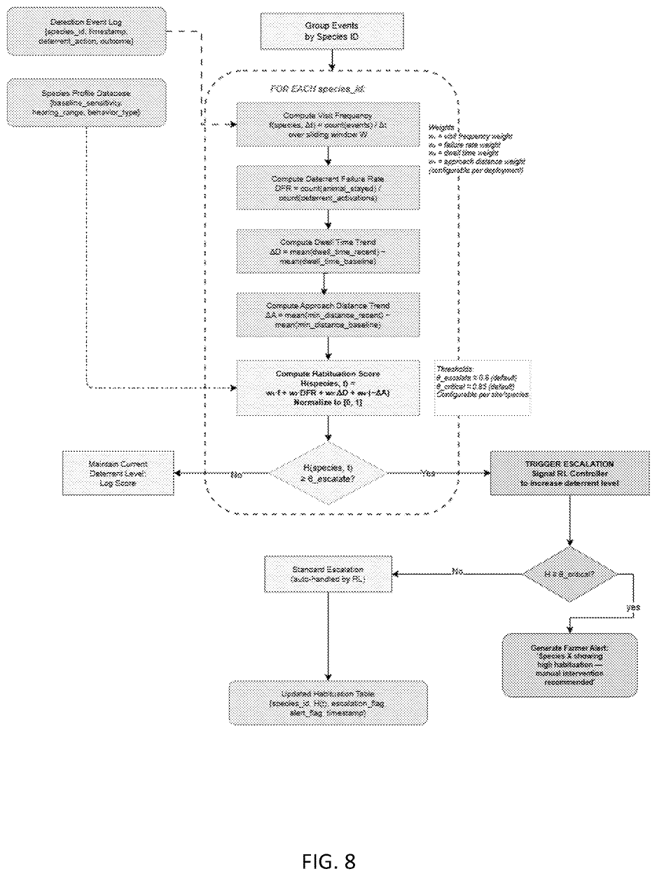

FIG. 8 illustrates a flow diagram of a habituation scoring engine showing the computation of per-species habituation scores and escalation trigger logic. Referring to FIG. 6, the habituation scoring engine 133 maintains a per-species habituation score H_c that quantifies the degree to which animals of species c have become desensitized to the system's deterrent stimuli over time.

The habituation score H_c is computed as an exponentially weighted moving average of response quality metrics over recent deterrent encounters with species c:

$$H\_c = 1. - EWMA ( R\_quality \_c , α )$$

Where R_quality_c is the response quality metric for each encounter (combining retreat success and response latency), and a is a smoothing factor that determines the engine's sensitivity to recent encounters versus historical trends. A habituation score of 0.0 indicates full responsiveness (no habituation); a score approaching 1.0 indicates near-complete habituation.

The habituation scoring engine 133 triggers the following escalation actions based on configurable thresholds:
(a) H_c>0.3 (Low habituation): The RL controller 132's exploration rate epsilon is increased to encourage broader strategy sampling.
(b) H_c>0.5 (Moderate habituation): Deterrent intensity ceiling is raised, and previously unused deterrent profiles are prioritized.
(c) H_c>0.7 (High habituation): Multi-modal escalation is triggered, combining ultrasonic and audible stimuli, varying onset timing, and activating multiple sound pods 200 in coordinated spatial patterns.
(d) H_c>0.9 (Critical habituation): An alert is sent to the operator via the remote management interface 400, recommending manual intervention or supplementary deterrent measures. The system continues operating with maximum deterrent variability.

The habituation score decays toward 0.0 during periods when no encounters with species c are recorded, reflecting the natural decrease in habituation when the stimulus is removed for extended periods.

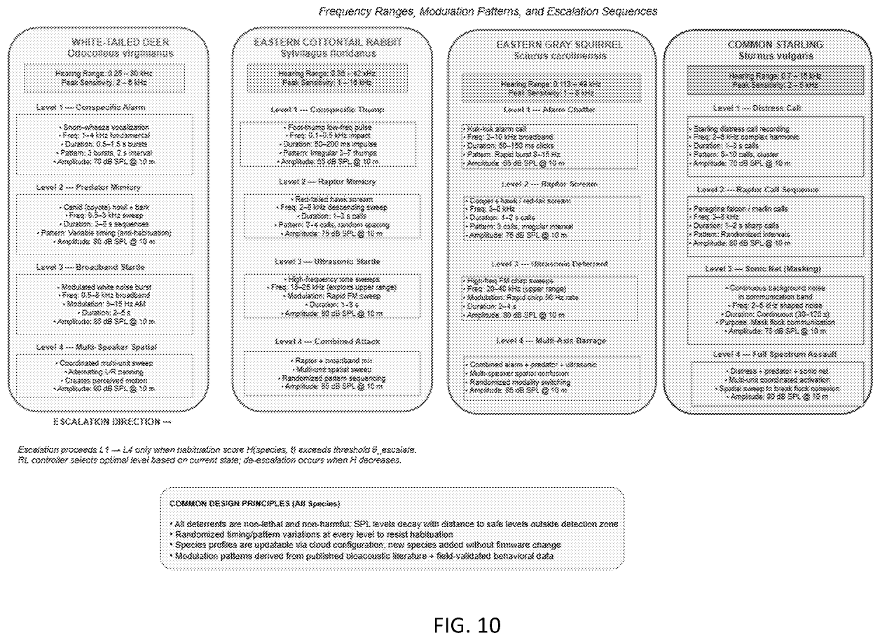

FIG. 10 illustrates a diagram of exemplary species-specific deterrent profiles showing frequency ranges, modulation patterns, and escalation sequences for deer (Odocoileus virginianus), eastern cottontail rabbit (Sylvilagus floridanus), eastern gray squirrel (Sciurus carolinensis), and common starling (Sturnus vulgaris). Referring to FIG. 10, the deterrent profile database stores species-specific acoustic deterrent parameters derived from published audiogram data and behavioral research for each target species. Example species profiles follow.

For white-tailed deer (Odocoileus virginianus): Primary aversive frequency range of 4-8 kHz corresponding to the peak sensitivity range of the cervine audiogram. Modulation patterns include amplitude-modulated sweeps simulating sudden onset predator vocalizations, frequency-hopping patterns across the 4-12 kHz range, and pulsed bursts with randomized inter-pulse intervals of 200-2000 ms. Escalation options include broadband noise bursts and predator vocalization playback in the 1-4 kHz range.

For eastern cottontail rabbit (Sylvilagus floridanus): Primary aversive frequency range of 10-20 kHz targeting the rabbit's enhanced high-frequency sensitivity. Modulation patterns emphasize rapid frequency sweeps and short burst durations (0.5-3 seconds) with unpredictable timing to exploit the species' startle reflex.

For eastern gray squirrel (Sciurus carolinensis): Ultrasonic frequency range of 20-38 kHz within the squirrel's extended ultrasonic hearing range. Both continuous and pulsed modulation patterns are employed, with particular emphasis on sudden onset signals that trigger acoustic startle.

For avian species (starlings, crows, blackbirds): Frequency range of 2-8 kHz corresponding to avian audiogram peaks. Deterrent signals include synthetic predator call patterns, distress call analogs, and broadband startle stimuli. Species-specific profiles for individual bird species are stored where sufficient audiometric data is available.

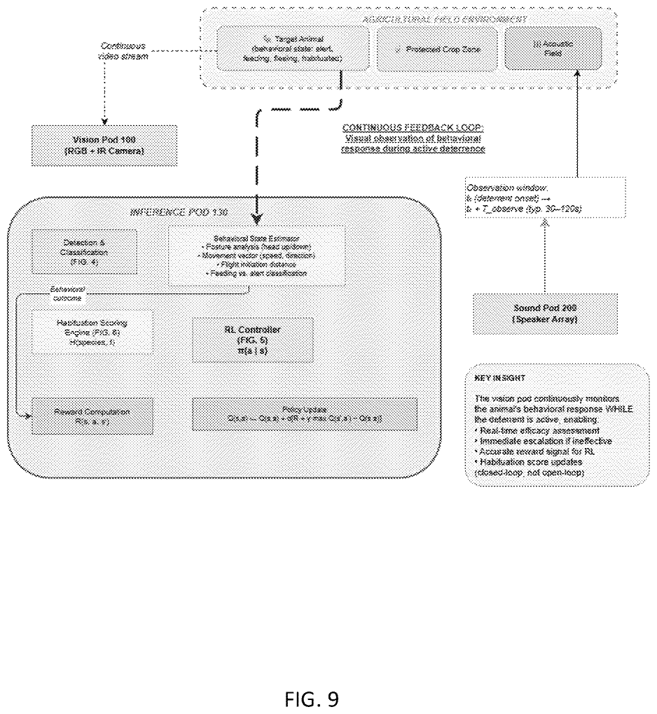

FIG. 9 illustrates a schematic of the closed-loop feedback architecture showing continuous visual observation of animal behavioral response during active deterrence. Referring to FIG. 9, the system 10 implements a continuous closed-loop feedback architecture that distinguishes it from prior art open-loop and rule-based systems. During active deterrence, the imaging sensor 110 of the vision pod 100 continues to capture and analyze frames throughout the deterrent emission period and for a configurable observation period (T_obs) after emission ceases. The behavioral state estimation (Stage 4 of the classification pipeline, as described herein) operates in real-time during this observation period, tracking the animal's trajectory, velocity, heading change, and postural indicators of alertness or flight.

This continuous observation provides the ground truth for the RL reward signal: the system directly measures whether the deterrent action achieved the desired behavioral outcome (retreat), partially succeeded (alerting without retreat), or failed (no observable response or approach). This empirical feedback is fundamentally different from prior art systems that either have no feedback mechanism or rely on aggregate statistics (e.g., daily bird counts) to assess deterrent effectiveness retrospectively.

FIG. 11 illustrates a deployment topology diagram showing multiple vision pods and sound pods distributed across an agricultural field with overlapping coverage zones. Referring to FIG. 11, the system 10 is designed for deployment as a distributed sensor-actuator network. In a typical deployment for a 5-acre specialty crop field, 2-4 vision pods 100 are positioned at elevated vantage points (mounted on poles at 2-3 meters height) to provide overlapping surveillance coverage of the field perimeter and entry corridors. Sound pods 200 are deployed at 15-30 meter intervals along the field perimeter and within interior rows, with each sound pod 200 addressable by its nearest vision pod 100 or by any vision pod 100 in the network via the wireless communication link 300.

When a vision pod 100 detects and classifies a wildlife intrusion, it transmits a deterrent command packet to the nearest sound pod(s) 200 via the wireless link 300. The command packet specifies: target species, deterrent profile ID, selected action parameters, and optionally directional information derived from the animal's detected location within the camera frame. Multiple sound pods 200 may be activated simultaneously or in sequence to create spatial deterrent patterns (e.g., sound “walls” that guide the animal's retreat direction).

FIG. 12 illustrates a timing diagram showing a representative deterrent escalation sequence triggered by habituation detection for a single deer encounter.

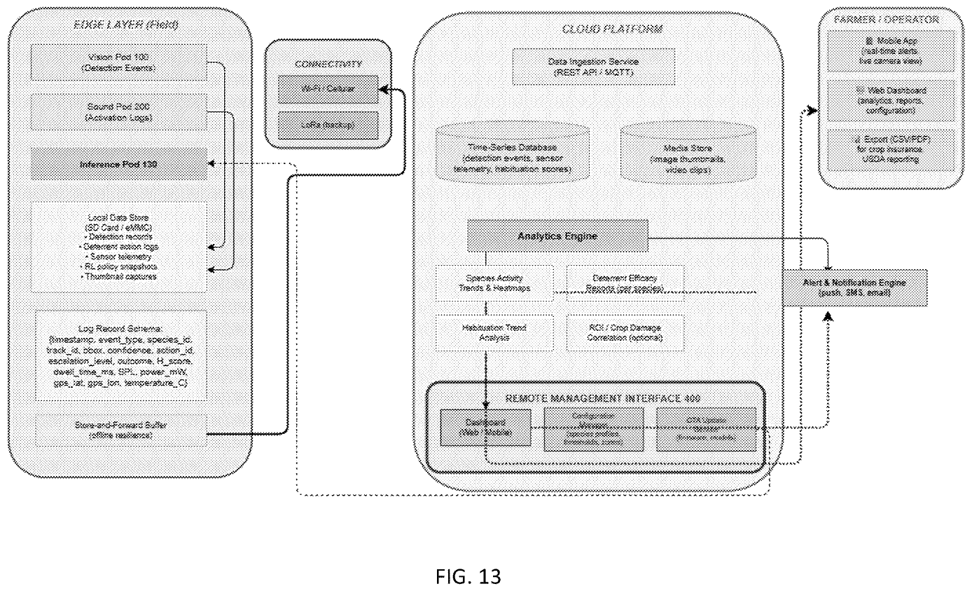

FIG. 13 illustrates a block diagram of the data logging and analytics subsystem including the remote management interface 400. Referring to FIG. 13, the data logging module 135 records each detection event, including: timestamp, species classification, confidence score, behavioral state, deterrent action selected, deterrent parameters, behavioral response observed, reward computed, and updated habituation score. This data is stored locally on the inference pod 130 and periodically synchronized to the remote management interface 400 when network connectivity is available.

The remote management interface 400 provides a dashboard accessible via web browser or mobile application, displaying: real-time detection event feed, species encounter frequencies over configurable time windows, habituation score trends per species, deterrent action success rates, system health metrics (battery level, solar generation, connectivity status), and configurable alerts for high-habituation or system anomaly conditions.

The aggregated data from multiple deployments contributes to a growing proprietary species-behavior dataset that informs the improvement of species classification models, refinement of deterrent profile parameters, and pre-training of RL policies for new deployments.

The system 10 is designed for autonomous, off-grid operation. The PIR-triggered wake architecture described in paragraph ensures that the inference pod 130 and imaging sensor 110 consume power only during detection and deterrence events, which typically constitute less than 5% of the system's operational time. During the remaining 95%+ idle time, the system draws only the PIR sensor's quiescent current (typically less than 0.5 mA), enabling solar-powered operation with modest panel and battery capacity.

The power management subsystem 150 implements a priority-based power allocation scheme: PIR monitoring has the highest priority and is never de-powered; inference pod wake and image capture have second priority; deterrent actuation has third priority; and data synchronization/upload has the lowest priority and is deferred during low-battery conditions.

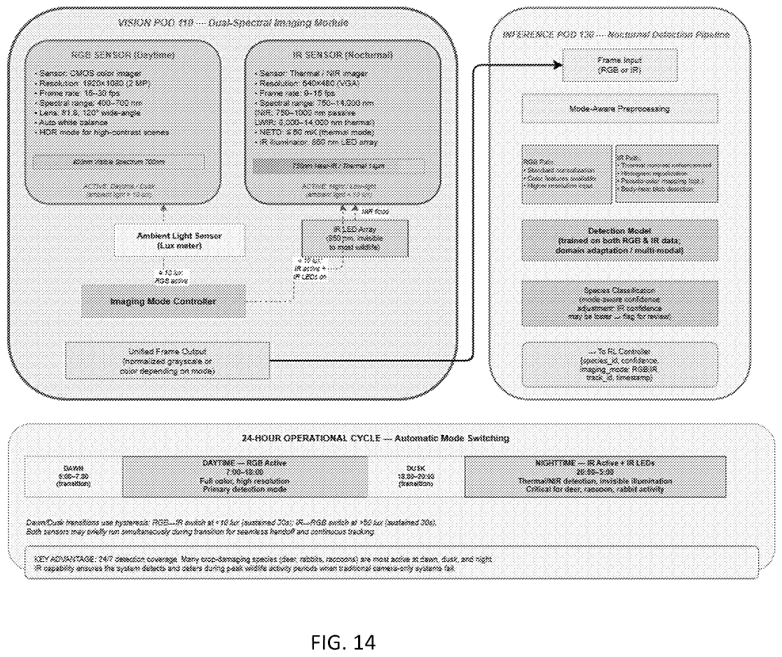

FIG. 14 illustrates a schematic of the dual-spectral imaging configuration showing combined RGB and infrared sensor operation for nocturnal detection.

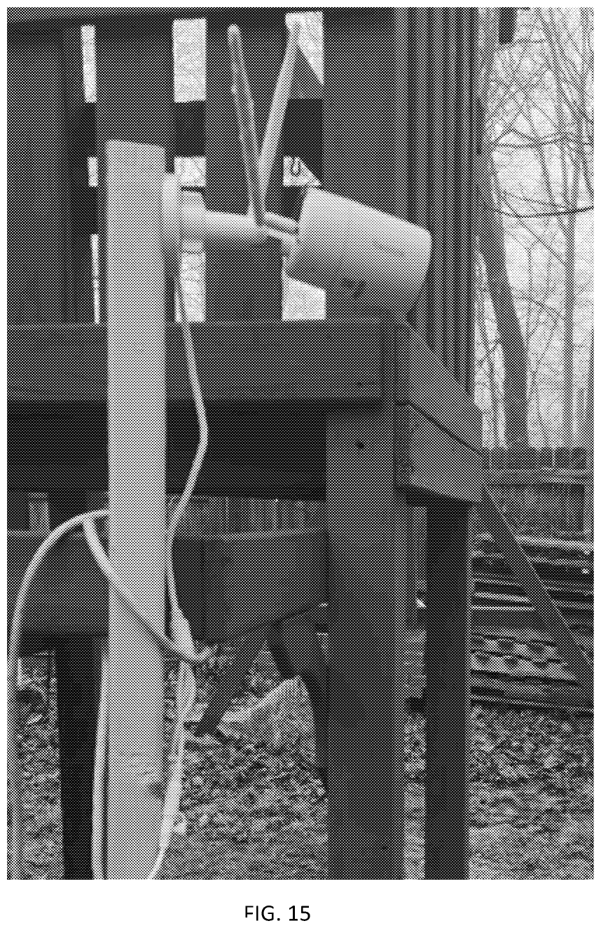

In experimentation, a system in accordance with embodiments of the present disclosure was constructed and deployed in an agricultural field environment. The system included three principal hardware components: a vision pod (e.g., corresponding to vision pod 100) for image capture, an inference pod (e.g., corresponding to inference pod 130) for edge-based artificial intelligence (AI)/machine learning (ML) processing, and a sound pod (e.g., corresponding to sound pod 200) for species-specific acoustic deterrence. FIGS. 15, 16, and 17 are images of a vision pod, an inference pod, and a sound pod, respectively, in accordance with embodiments of the present disclosure.

Referring to FIG. 15, this example vision pod is a COTS camera unit mounted in a weatherproof enclosure. This vision pod can provide continuous visual monitoring of a protected crop zone.

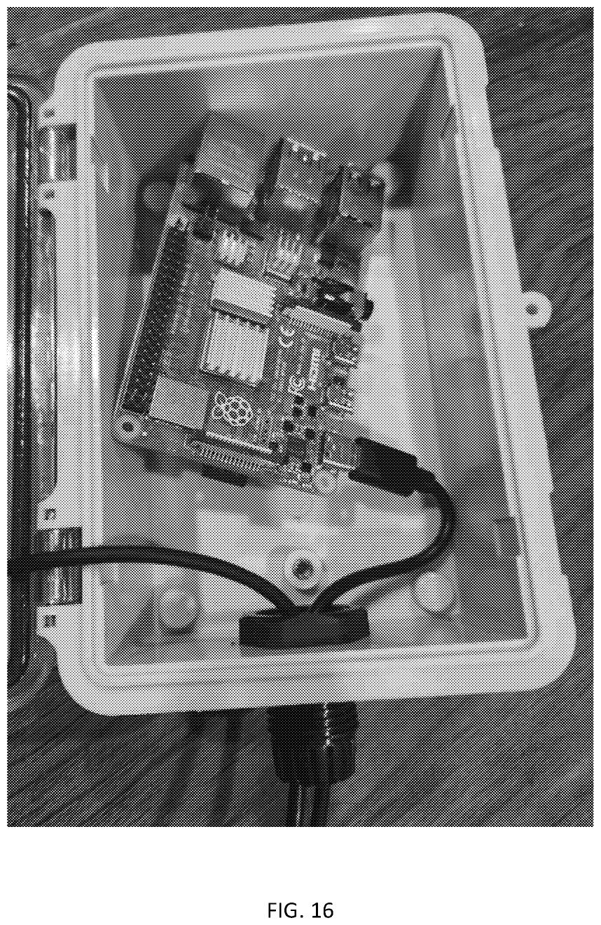

Referring to FIG. 16, this image shows an edge-computing unit housing a trained animal classification model, a reinforcement learning controller, and a habituation scoring engine. This inference pod can process detections in real time.

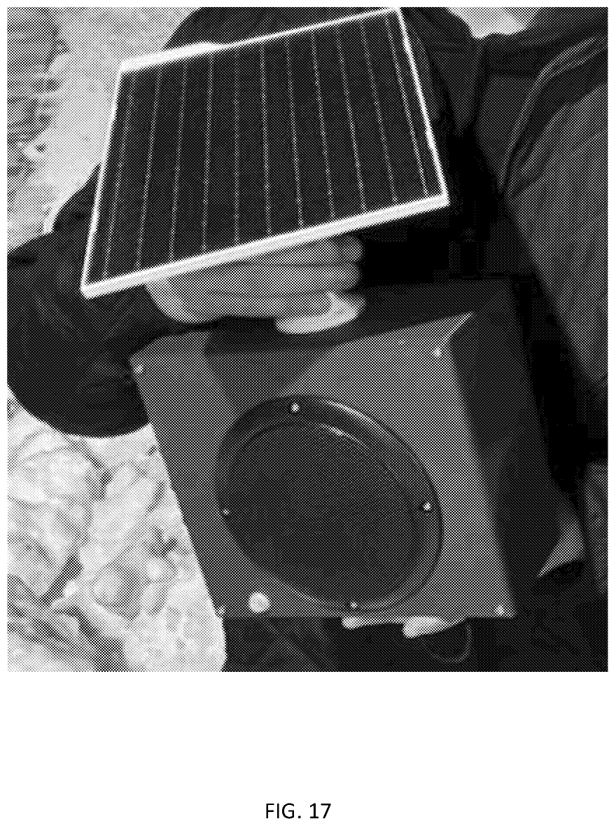

Referring to FIG. 17, this image shows a sound pod (or an acoustic deterrent unit) for mounting on a field post. The sound pod includes a weatherproof housing rated for multi-season outdoor agricultural deployment. A directional speaker array is shown in the image.

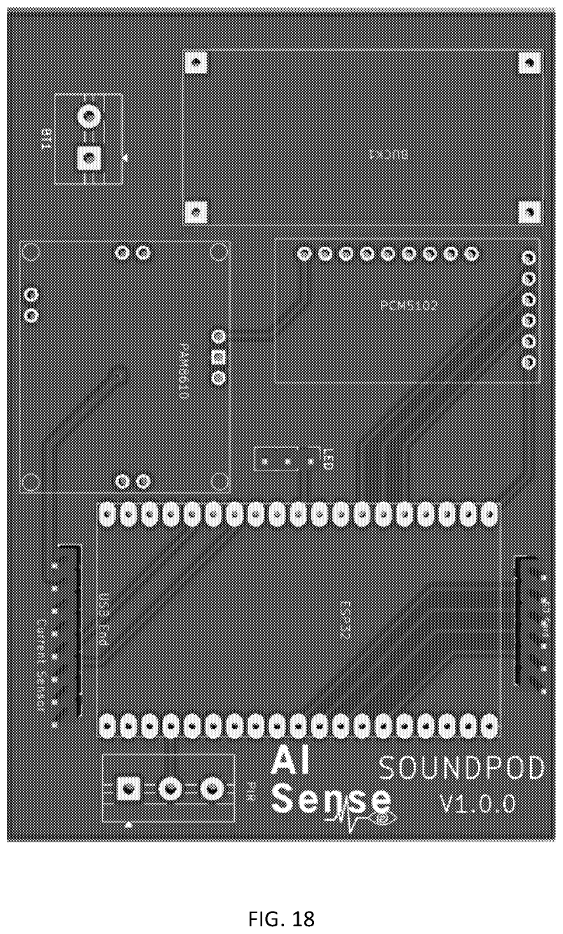

FIG. 18 illustrates a sound pod printed circuit board (PCB) including an ESP32 microcontroller, a PCM5102 DAC, a PAM8610 amplifier, a PIR motion sensor, an SD card module, and a current sensor.

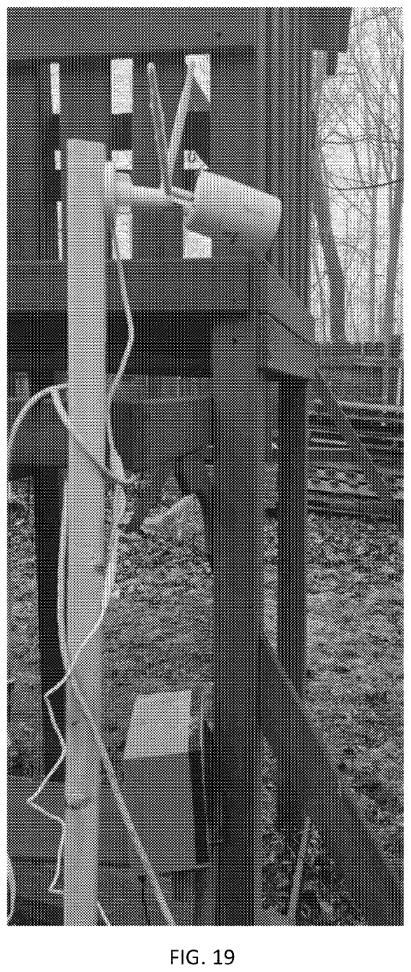

FIG. 19 is an image showing an integrated AI system in accordance with embodiments of the present disclosure as deployed on an active specialty crop farm. This image depicts an example of the spatial arrangement of the vision pod, the inference pod, and sound pod units for protecting crop rows.

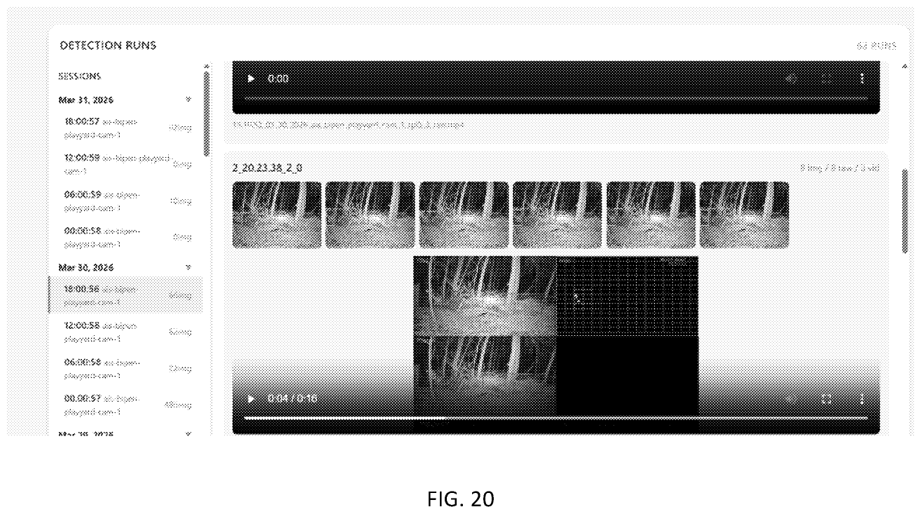

FIG. 20 shows an example screenshot of a cloud-based remote management interface showing real-time detection events, habituation score dashboards, deterrent activation logs, and system health monitoring.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system comprising:
at least one activity sensor configured to detect activity in a monitored area;
at least one imaging sensor configured to acquire image data of an animal in the monitored area in response to detection of activity by the at least one activity sensor;
an animal deterrence manager configured to:
determine a species of the animal based on the acquired image data;
determine a deterrent profile based on the determined species;
determine a deterrent command based on the deterrent profile;
communicate the deterrent command to a stimulus device for implementing a deterrent action;
observe a behavioral response of the animal to the deterrent action using the at least one imaging sensor; and
update a learned policy based on the observed behavioral response of the animal.

2. The system of claim 1, wherein the at least one activity sensor comprises a passive infrared motion sensor configured to generate a trigger signal in response to detection of a thermal motion signature in the monitored area.

3. The system of claim 1, wherein the at least one imaging sensor comprises a camera configured to capture image data of the monitored area in response to detection of activity by the at least one activity sensor.

4. The system of claim 3, wherein the camera comprises a dual-spectral imaging configuration including an RGB image sensor and a near-infrared image sensor configured to capture image data.

5. The system of claim 1, wherein the animal deterrence manager is configured to determine the species of the animal by executing a machine-learned classification model by use of the acquired image data.

6. The system of claim 5, wherein the machine-learned classification model comprises an object detection model configured to output a bounding box and a species label for the animal within a field of view of the at least one imaging sensor.

7. The system of claim 6, wherein the object detection model is based on a You Only Look Once (YOLO) architecture or a MobileNet-SSD architecture optimized for edge deployment.

8. The system of claim 1, wherein the animal deterrence manager is configured to retrieve deterrent parameters associated with the determined species from a deterrent profile database for determining the deterrent profile based on the determined species.

9. The system of claim 8, wherein the deterrent profile specifies at least one of: a frequency range, an amplitude envelope, a modulation pattern, a temporal duration, and an intensity level for a deterrent stimulus.

10. The system of claim 9, wherein the deterrent profile is selected from a plurality of species-specific deterrent profiles each derived from an audiogram corresponding to a respective animal species.

11. The system of claim 1, wherein the stimulus device comprises at least one acoustic emitter configured to emit an acoustic deterrent signal in response to the deterrent command.

12. The system of claim 11, wherein the acoustic emitter is configured to emit signals in a predetermined ultrasonic frequency range and a predetermined audible frequency range.

13. The system of claim 12, wherein the stimulus device comprises an array of speakers including a piezoelectric ultrasonic transducer and a dynamic cone speaker.

14. The system of claim 1, wherein the stimulus device comprises at least one additional deterrent actuator including a light emitter, a mechanical actuator, and/or a combined audio-visual deterrent device.

15. The system of claim 1, wherein the learned policy maps system states to deterrent actions and is updated using a reinforcement learning algorithm.

16. The system of claim 15, wherein a system state used by the learned policy comprises at least the determined species, a time of day, an ambient light level, and a measure of prior responsiveness of the determined species to deterrent actions.

17. The system of claim 15, wherein the animal deterrence manager is configured to compute a reward signal indicative of an effectiveness of the deterrent action and adjusting the learned policy based on the reward signal for updating the learned policy based on the observed behavioral response of the animal.

18. The system of claim 17, wherein the reward signal is based at least in part on whether the animal exits a protected zone within a specified observation period after execution of the deterrent action.

19. The system of claim 1, wherein the animal deterrence manager is configured to maintain, for each of a plurality of species, a habituation score indicative of a temporal trend in behavioral responsiveness of the respective species to deterrent actions.

20. The system of claim 19, wherein the animal deterrence manager is configured to increase an exploration parameter used by the learned policy when the habituation score for the determined species exceeds a first threshold.

21. The system of claim 19, wherein the animal deterrence manager is configured to trigger an escalation protocol that modifies at least one deterrent parameter when the habituation score for the determined species exceeds a second, higher threshold.

22. The system of claim 1, wherein the animal deterrence manager is configured to track at least one of a trajectory, a velocity, and a heading change of the animal over an observation interval following execution of the deterrent action for observing the behavioral response of the animal to the deterrent action.

23. The system of claim 22, wherein the animal deterrence manager is configured to classify the behavioral response into one of a plurality of behavioral states including at least approaching, stationary, alert, and retreating, and to use the behavioral state as input to the learned policy.

24. The system of claim 1, further comprising a communication interface configured to transmit the deterrent command from the animal deterrence manager to the stimulus device over a wireless communication link.

25. The system of claim 1, further comprising a plurality of stimulus devices distributed across the monitored area, wherein the animal deterrence manager is configured to select a subset of the plurality of stimulus devices to receive the deterrent command based at least on a location of the animal within the monitored area.

26. The system of claim 1, wherein the animal deterrence manager comprises an edge processor configured to perform animal species determination, deterrent profile determination, deterrent command generation, observation of behavioral response, and update the learned policy.

27. A system comprising:
at least one activity sensor configured to detect activity in a monitored area;
at least one imaging sensor configured to acquire image data of an animal in the monitored area in response to detection of activity by the at least one activity sensor; and
an animal deterrence manager configured to:
classify a detected animal by species by use of a machine-learned model based on the image data;
determine a system state based on the classified species, a time-of-day indicator, an environmental condition indicator, and/or a habituation metric associated with the classified species;
determine deterrent control data based at least on the system state;
cause at least one stimulus device to implement a deterrent action according to the deterrent control data;
analyze subsequent sensor data to determine a behavioral response of the animal to the deterrent action; and
update a learned policy that governs selection of deterrent actions and the habituation metric based at least on the determined behavioral response.

28. The system of claim 27, wherein the at least one activity sensor comprises a passive infrared motion sensor configured to generate a trigger signal in response to detection of a thermal motion signature in the monitored area.

29. The system of claim 27, wherein the at least one imaging sensor comprises a camera configured to capture video of the monitored area, and the machine-learned model is configured to process the video to classify the detected animal by species.

30. The system of claim 27, wherein the animal deterrence manager is configured to maintain the learned policy using a reinforcement learning algorithm that updates an action-value function or a policy function based on the determined behavioral response.

31. The system of claim 27, wherein the animal deterrence manager is configured to form a state vector including at least the classified species, the time-of-day indicator, the environmental condition indicator, and the habituation metric associated with the classified species for determining the system state.

32. The system of claim 27, wherein the animal deterrence manager is configured to select a deterrent action from among a plurality of candidate deterrent actions stored in a deterrent profile database based at least on the system state for determining deterrent control data.

33. The system of claim 27, wherein the animal deterrence manager is configured to track at least one of a trajectory, a velocity, and a heading change of the animal after implementation of the deterrent action for analyzing subsequent sensor data.

34. The system of claim 27, wherein the animal deterrence manager is configured to compute the habituation metric as a function of behavioral responses observed over a plurality of deterrent encounters with animals of the classified species.

35. The system of claim 27, wherein the animal deterrence manager is configured to:
update the learned policy based the determined behavioral response comprises computing a reward signal indicative of an effectiveness of the deterrent action; and
adjust the learned policy based on the reward signal.

36. The system of claim 27, wherein the at least one stimulus device comprises a plurality of stimulus devices distributed across the monitored area, and
wherein the animal deterrence manager is configured to select a subset of the plurality of stimulus devices to implement the deterrent action based at least on a location of the detected animal within the monitored area.

37. A system comprising:
an animal deterrence manager configured to:
maintain, for each of a plurality of wildlife species, a habituation score quantifying a temporal trend in behavioral responsiveness of the respective species to deterrent stimuli implemented by the system;
for each deterrent encounter with an animal of a given species, compute a response quality metric from sensor data indicative of a behavioral response of the animal to a deterrent action;
update the habituation score for the given species based on the computed response quality metric;
modify one or more control parameters governing selection of deterrent actions so as to adjust at least one of a diversity, intensity, or timing of deterrent stimuli applied to the given species in response to the habituation score meeting at least one escalation condition; and
transmit an alert to an operator via a remote management interface in response to the habituation score meeting an alert condition.

38. The system of claim 37, wherein the deterrent stimuli implemented by the system comprise acoustic deterrent signals emitted by at least one acoustic emitter in at least one of an ultrasonic frequency range and an audible frequency range.

39. The system of claim 37, wherein the sensor data indicative of the behavioral response comprises image data captured by an imaging sensor, and
wherein the animal deterrence manager is configured to analyze at least one of a trajectory, a velocity, and a heading change of the animal after the deterrent action for computing the response quality metric.

40. The system of claim 37, wherein the escalation condition comprises the habituation score for the given species exceeding a first threshold and a second, higher threshold, and
wherein the animal deterrence manager is configured to, for the first threshold, increase a degree of variation in selected deterrent actions and, for the second threshold, increasing at least one of an intensity or duration of the deterrent stimuli for modifying the one or more control parameters.

41. The system of claim 37, wherein the one or more control parameters comprise at least one randomization parameter of a reinforcement learning controller that maintains a learned policy for deterrent action selection, and
wherein the animal deterrence manager is configured to adjust the randomization parameter based on the habituation score for the given species modifying the one or more control parameters.
